(19) United States
(12) Patent Application Publication
(10) Pub. No.: US 2026/0200671 A1
(43) Pub. Date: Jul. 16, 2026

(54) OPERATING STAND AND STORAGE SYSTEM

(71) Applicant: LTW Intralogistics GmbH, Wolfurt (AT)

(72) Inventors: Alexander LANG, Leiben (AT); Alexander DEEG, Bregenz (AT); Matthias SCHWARZMANN, Andelsbuch (AT)

(73) Assignee: LTW Intralogistics GmbH, Wolfurt (AT)

(21) Appl. No.: 19/560,389

(22) Filed: Mar. 9, 2026

Related U.S. Application Data
(63) Continuation of application No. PCT/EP2024/074510, filed on Sep. 3, 2024.

(30) Foreign Application Priority Data
Sep. 8, 2023 (DE) 10 2023 124 284.9

(51) Int. Cl. B65G 1/04; G05B 19/409

(52) U.S. Cl. CPC B65G 1/0421; G05B 19/409; G05B 2219/33004; G05B 2219/45054

(57) ABSTRACT

An operating stand for a conveyor device which comprises a stationary operating part and a mobile operating part that is paired with the stationary operating part, wherein the stationary operating part comprises at least one safety-relevant safety device which can be actuated by a user, wherein the mobile operating part can be physically separated from the stationary operating part, and wherein the mobile operating part comprises a user interface, which can be operated by the user, for manually controlling at least one non-safety-relevant function of the conveyor device. The invention additionally relates to a storage system comprising such an operating stand.

This nonprovisional application is a continuation of International Application No. PCT/EP2024/074510, which was filed on Sep. 3, 2024, and which claims priority to German Patent Application No. 10 2023 124 284.9, which was filed in Germany on Sep. 8, 2023, and which are both herein incorporated by reference.

### BACKGROUND OF THE INVENTION

### Field of the Invention

The invention relates to an operating stand for a conveyor device, in particular for a storage conveyor. Additionally, the invention relates to a storage system comprising such an operating stand and having at least one conveyor, preferably in the form of a storage and retrieval machine.

### Description of the Background Art

It is known to position operating stands in the form of external control stations outside of danger zones in which the conveyor device executes driving, lifting and/or lowering commands. The operating stand in the form of an external control station is therefore positioned in an area that is not dangerous for the user (operator), which area is often also referred to as the user's working and/or traffic area.

Concepts for access control or secure access to danger zones for maintenance purposes can be found in publications EP 3 505 466 A1 or DE 20 2021 103 304 U1, which are incorporated herein by reference.

### SUMMARY OF THE INVENTION

It is therefore the object of the present invention to provide an operating stand and a storage system which provides a simplified operating concept for the user, in compliance with the necessary safety measures.

In the context of the present disclosure, “operating stand” is not necessarily to be only understood as a standing element. Rather, the operating stand can also be formed, for example, as a hanging or self-supporting element. The an important aspect is that it includes a stationary operating part that is fixed in the storage location.

An operating stand is a location from which the conveyor device can be controlled. For example, an external control station, an emergency control station and a ride-on operator's platform that travels on the conveyor device can be considered as an operating stand. An external control station is a location outside the danger zone of the conveyor device, from which the movements of the conveyor device can be controlled. An emergency control station is an operating stand on the conveyor device or within the danger zone of the conveyor device, from which the conveyor device can be controlled in the event of a malfunction (emergency) or during maintenance work. A ride-on operator's platform is a protected stand on the conveyor device, from which the movements of the conveyor device can be controlled.

The operating stand for a conveyor device according to the invention is characterized by a stationary operating part that is paired with a mobile operating part according to the invention. The stationary operating part is fixedly placed; it is immovable. The stationary operating part comprises at least one safety-relevant safety device which can be actuated by a user, wherein the mobile operating part can be physically separated from the stationary operating part, and the mobile operating part comprises a user interface, which can be operated by the user, for manually controlling at least one non-safety-relevant function of the conveyor device. The mobile operating part can therefore be moved to a different location; it can be moved manually by a person.

Such a semi-mobile approach with fixed, stationary operating parts and mobile operating parts has the following advantages: The stationary operating parts remain stationary in positions within the storage location that are defined as “safe” positions and are outside the danger zone. It is possible for a single mobile operating part to also be paired with multiple stationary operating parts, so that the mobile operating part can be carried from a first stationary operating part to another stationary operating part. The mobile operating part can then be coupled with the desired stationary operating part, wherein the other operating parts could also be decoupled in this case. This semi-mobile approach ensures that the safety-relevant function(s) remain an integral part of the stationary operating part. This means that no other safety functions are required on the conveyor device itself.

For conveyor devices used to handle racks, it has proven to be advantageous if the safety device is selected from the group including emergency stop buttons, operating mode selector switches (e.g., in the form of a key switch) and enabling buttons. It is possible that several of the above elements of the group are also present in the stationary operating part.

In order to make handling as easy as possible for a user, it has been found to be preferable that the mobile operating part be equipped with a microprocessor, with the user interface preferably in the form of an input device or in the form of a touch screen, and that the mobile operating part for controlling the conveyor device is set up in such a way that a communication link with a programmable logic controller (PLC) of the conveyor device is established directly and at least temporarily maintained. This communication link can be wired or wireless, for example. For example, a LAN or Ethernet connection is implemented as a wired connection (Local Area Network; Standard according to IEEE 802.3, in particular 802.3bd and later, preferably 802.3de (as of 2022)). A wireless connection is preferably implemented via WLAN (Wireless Local Area Network; IEEE 802.11 standard, in particular IEEE 802.11-2012 and later, preferably IEEE 802.11-2016; preferably IEEE 802.11ac, IEEE 802.11ax, IEEE 802.11ad or IEEE 802.11ah). This direct link between the mobile operating part and the conveyor device's programmable logic controller is particularly useful for time-critical applications, such as buttons on the user interface of the mobile operating part for keyboard commands or manual reset. Driving, lifting and/or lowering commands should therefore be carried out in real time as far as possible. A communication protocol according to HTTPS (Hypertext Transfer Protocol Secure) is preferably used here, as this ensures that all data is transmitted as bug-proof and tamper-proof as possible.

As an alternative or in addition, it is possible for the mobile operating part to be set up in such a way as to establish and, at least temporarily, maintain a communication connection with a higher-level visualization server, which is in a communication connection with a programmable logic controller (PLC) of the conveyor device. In this way, it is possible to display the status of the storage system or the conveyor device on the mobile operating part via a browser. The connection to the visualization server is preferably either wired via Ethernet (standard according to IEEE 802.3, especially 802.3bd and later, preferably 802.3de (as of 2022)) or wirelessly via WLAN (standard according to IEEE 802.11, especially IEEE 802.11-2012 and later, preferably IEEE 802.11-2016; preferably IEEE 802.11ac, IEEE 802.11ax, IEEE 802.11ad or IEEE 802.11ah).

This connection between the mobile operating part and the visualization server is generally used for non-time-critical applications, such as messages or other display values, wherein an HTTPS communication protocol (Hypertext Transfer Protocol Secure) is preferably used for transmission. The communication link between the visualization server and the programmable logic controller (PLC) is preferably realized via an OPC-UA connection (Open Platform Communications Unified Architecture; Standard for data exchange as a platform-independent, service-oriented architecture (SOA)). In both cases, the transmission protocol is characterized by its good eavesdropping and tampering protection.

The number of buttons or switches can be reduced, for example if a separate operating mode selector switch is dispensed with. With the operating mode selector switch, the conveyor device can be switched between automatic operation, in which the conveyor device automatically carries out storage and/or retrieval operations in the storage location, and manual operating mode, in which driving, lifting and/or lowering commands and, if necessary, commands for adjusting the load handling device (e.g., shuttle, crawler or load fork) can be specified manually and then executed. However, to increase safety, automatic operation can only be set in very specific situations or constellations, in particular when there is no one in the danger zone of the storage facility or the conveyor device.

In this context, it is advantageous if the stationary operating part comprises a first interface part of an operating stand interface, if the mobile operating part comprises a second interface part of the operating stand interface that complements the first interface part, and if automatic operation of the conveyor device is only possible if the first interface part and the second interface part are coupled together. The operating stand interface can be realized, for example, by electrical contacts that have to physically touch each other. However, the operating stand interface can also be detected via Bluetooth (Bluetooth 4.0 and higher, especially Bluetooth 4.2 smart, preferably Bluetooth 5.4) or by RFID (radio-frequency identification), preferably via NFC (near field communication), so that the mobile operating part can also be coupled with the stationary operating part if the mobile operating part is not in physical contact but is still close to the stationary operating part.

To increase safety within the storage location, it has proven to be advantageous if the conveyor device automatically switches from automatic operation to manual operating mode when the operating stand interface is decoupled. This constellation makes the use of a separate operating mode selector switch (for example in the form of a key switch) obsolete and saves space.

In order to be able to meet the normative requirements of access security, it has proven to be advantageous if the mobile operating part comprises a first interface part of an access interface that is paired with a safety barrier that can be adjusted between an open and a closed position. The coupling of the first interface part of the access interface with a second interface part of the access interface, which complements the first interface part, subsequently causes the safety barrier to be transferred to the open position. This means that the mobile operating part can provide a key itself or act as a key to gain access to a danger zone, for example for maintenance purposes. The access interface is again preferably implemented as a wireless interface, wherein data exchange (key exchange) is preferably carried out via Bluetooth or RFID or preferably via NFC.

Preferably, the manual operating of at least one non-safety-relevant function is a driving command for the conveyor device. However, lifting and lowering commands can also be issued and executed by the conveyor device. In addition, commands can be issued for the load handling device and then executed by the conveyor device, for example moving a crawler or a load fork into or out of a storage compartment.

The advantages, examples and effects explained in connection with the operating stand according to the invention apply in the same way to the storage system according to the invention, which includes such an operating stand.

The storage system according to the invention thus has an operating stand, as well as a conveyor device that is or can be paired with the operating stand for the storage and retrieval of goods, in particular general cargo.

At least one safety-relevant safety device that can be operated by a user is preferably wired to an input card of a programmable logic controller (PLC) of the conveyor device. Communication is preferably via Ethernet (standard according to IEEE 802.3, especially 802.3bd and later, preferably 802.3de (as of 2022)). This ensures that safety-relevant signals are transmitted reliably and are not transmitted due to a connection interruption, as could occur with a wireless connection.

In the storage system, the mobile operating part may also be equipped with a microprocessor and include a user interface, preferably in the form of an input device or in the form of a touch screen. The mobile operating part for controlling the conveyor device is set up in such a way that a communication link with a programmable logic controller (PLC) of the conveyor device can be established directly and maintained, at least temporarily. Such a connection is particularly used for time-critical applications, such as pressing buttons for driving, lifting and/or lowering commands. The manual reset of the conveyor device is also possible in this way. The connection of the mobile operating part and the programmable logic controller is preferably implemented via the HTTPS communication protocol in order to be able to transmit data as bug-proof and tamper-proof as possible.

In particular, the mobile operating part is also set up in such a way that a communication link is established and maintained at least temporarily with a higher-level visualization server, which in turn is in a communication connection with a programmable logic controller of the conveyor device. Such a connection is used for non-time-critical applications, such as messages or other display values. The connection between the mobile operating part and the visualization server is preferably realized via the HTTPS communication protocol, which means that data is transmitted in a way that is safe from eavesdropping and tampering. The connection between the visualization server and the programmable logic controller of the conveyor device is preferably made via a communication protocol according to Open Platform Communications Unified Architecture (see above). In this case, the programmable logic controller prefers to accept only connections with “Security Policy” “Sign and Encrypt”, which also transmits data in a way that is safe from eavesdropping and tampering.

The stationary operating part preferably comprises a first interface part of an operating stand interface, wherein the mobile operating part comprises a second interface part of the operating stand interface, which is complementary to the first interface part. In particular, automatic operation of the conveyor device is only possible if the first interface part and the second interface part are coupled together.

It is possible that when the operating stand interface is decoupled, the conveyor device automatically switches from automatic operation to manual operating mode.

It is possible for the mobile operating part to be used as a key to access the danger zone. In this context, it is advantageous if there is a safety barrier, which can be adjusted between an open and a closed position (for example, a mesh fence with a lockable access door) and which separates the user's working and/or traffic area from the danger zone in which the conveyor device is located and performs work tasks. In this case, the mobile operating part comprises a first interface part of an access interface of the safety barrier, wherein the coupling of the first interface part of the mobile operating part with a second interface part of the access interface, which is complementary to the first interface part and paired with the safety barrier, causes the safeguard to be transferred from the closed position to the open position.

The features and combinations of features mentioned above in the description, as well as the features and combinations of features and combinations of features mentioned below in the figure description and/or shown in the figure alone, can be used not only in the respective specified combination, but also in other combinations or in isolation, without departing from the scope of the invention. Thus, embodiments are also to be regarded as covered and disclosed by the invention which are not explicitly shown or explained in the figure, but which emerge from the explained embodiments by means of separate combinations of features and can be produced by means of them.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic plan view of a storage system with an operating stand (control station);

FIG. 2 is a schematic view of an operating stand (control station), wherein the individual constituents and communication links involved in the control system are additionally illustrated; and

FIG. 3 is a schematic view of the safety barrier and the access process using the mobile operating part of the operating stand from FIG. 2.

### DETAILED DESCRIPTION

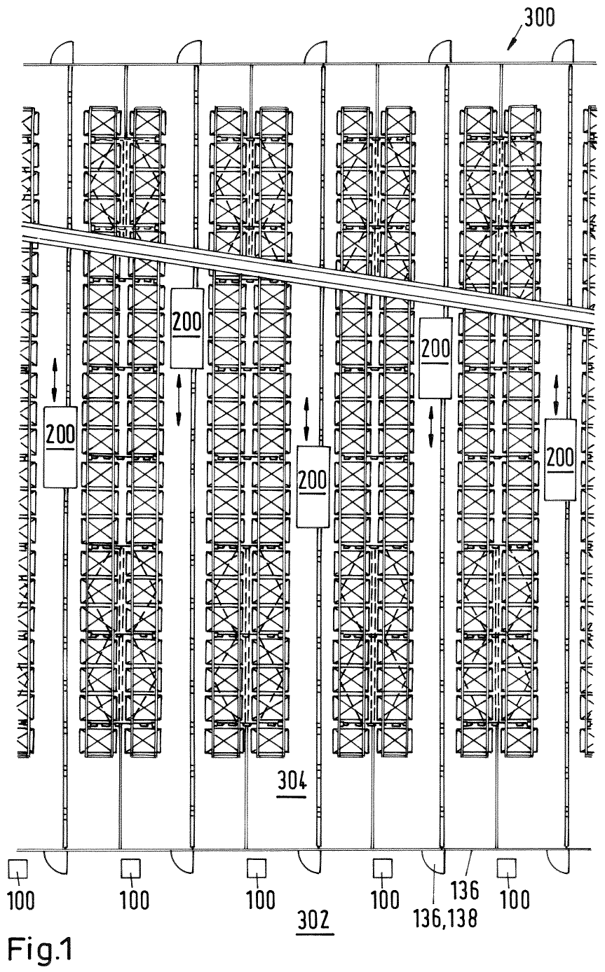

FIG. 1 shows a storage system 300 in a plan view, which in this case is formed as a high-bay storage location. The high-bay storage location comprises several rows of racks, wherein a conveyor device 200 is located between each pair of rack rows, which is formed, purely by example, as a storage conveyor, in particular as a storage and retrieval machine. The conveyor device 200 can be moved along the rack aisles between the rows of racks and is also designed as an aisle-bound storage and retrieval machine in the present case, also purely by example. It is possible to use conveyor devices 200 that can switch rack aisles. The area in which the conveyor device 200 executes its commands is called the danger zone 304. In this danger zone 304, the conveyor device 200 automatically executes storage commands when it is in so-called automatic operation mode. Users are only allowed to stay outside the danger zone 304 when automatic operation is switched on for the conveyor device 200. This means that users can move freely in the working and/or traffic area 302, which is separated from the danger zone 304 by a safety barrier 136. For maintenance purposes or to rectify malfunctions, the danger zone 304 may be entered via one or more access doors 138, but only if the conveyor device is no longer in automatic mode or at least part of the danger zone 304 is closed to storage commands of the storage rack conveyor device.

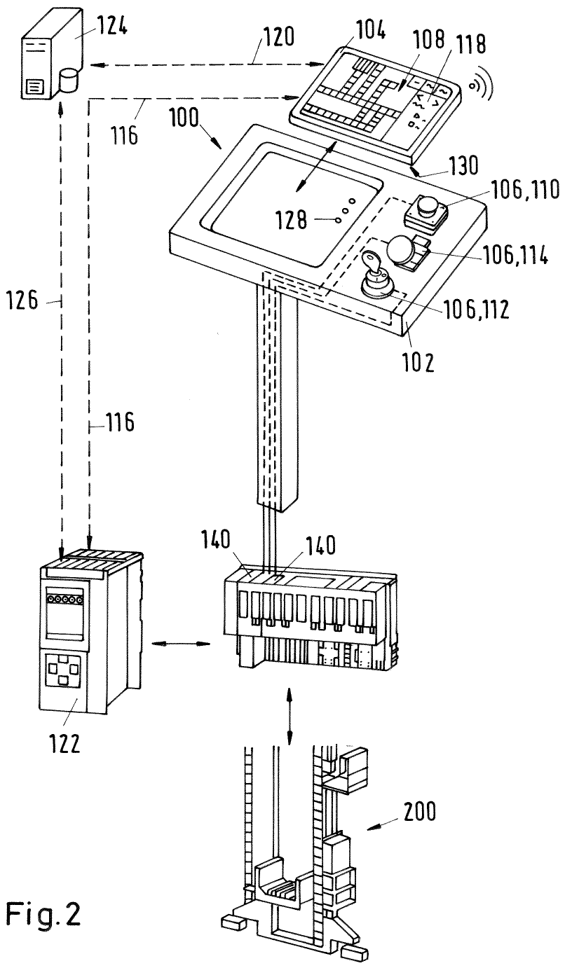

In the present case, each conveyor device 200 is paired with its own operating stand 100, which is also to be understood as a control station, since it does not necessarily have to be a “stand on the ground”. Such an operating stand 100 is illustrated in more detail in FIG. 2.

In the present case, it is formed in at least two parts, formed of a stationary operating part 102 and a mobile operating part 104. In the present case, the mobile operating part is embodied as a tablet computer or a smartphone. In any case, the mobile operating part 104 is paired with the stationary operating part 102. It can be seen that the stationary operating part 102 has different operations, which in the present case are formed as safety-relevant safety devices 106 that can be operated by a user. Purely by example, the safety devices 106 shown are an emergency stop button 110, which brings the conveyor device 200 to an immediate stop when operated, furthermore an operating mode selector switch 112, which, purely by example, is formed as a key switch, which, when actuated, switches the conveyor device 200 from automatic to manual mode, and an enabling button 114, with which, for example, a user gives permission to release the movement of a drive. In particular, it can also be confirmed that the conveyor device 200 is to return to automatic operation.

If the key switch 112 is flipped, the key can be removed from the keyhole of the key switch 112 and used as a key to unlock the access door 138 to the danger zone 304. With the mobile operating part 104, a user can then manually issue driving commands, lifting commands, lowering commands, or commands for the load handling device, which are carried out directly by the conveyor device 200. For this purpose, the mobile operating part 104 is equipped with a microprocessor, wherein a user interface 108 is available for manually controlling at least one non-safety-relevant function of the conveyor device 200; in the present case, the user interface is implemented by a touchscreen 118.

FIG. 2 also illustrates that the mobile operating part 104 for controlling the conveyor device 200 is set up in such a way that a communication link 116 with a programmable logic controller 122 of the conveyor device 200 is established directly and maintained, at least temporarily. In this way, time-critical applications, such as issuing commands to adjust the conveyor device 200, can be carried out almost in real time.

In addition, the mobile operating part 104 is set up in such a way that a communication link 120 is established and maintained, at least temporarily, with a higher-level visualization server 124, which is also in a communication link 126 with the programmable logic controller 122 of the conveyor device 200. This way, the current status of the storage system 300 can be displayed on the touchscreen 118 of the mobile operating part 104 via a browser. The communication link 120 via the visualization server 124 is used for time-critical applications, such as messages or other display values.

Furthermore, it can be seen that the safety-relevant safety devices 106 are directly connected and wired to input cards 140 of the programmable logic controller 122 of the conveyor device 200. Due to this cable connection, connection security is also guaranteed, so that the connection cannot fail and safety-critical applications can be executed immediately and fail-safe if necessary.

With the semi-mobile approach of a control station (operating stand 100) shown in FIG. 2, an additional safety concept can also be implemented. For this purpose, the stationary operating part 102 comprises a first interface part 128 of an operating stand interface, wherein the mobile operating part 104 comprises a second interface part 130 of the operating stand interface that is complementary to the first interface part 128. In the present case, automatic operation of the conveyor device 200 is only possible if the first interface part 128 and the second interface part 130 are coupled together. In the present case, the coupling is carried out via electrical contacts, wherein wireless coupling is also possible. So if the mobile operating part 104 is physically connected to the stationary operating part 102, the conveyor device 200 can be operated in automatic mode. In addition, it is possible that when the operating stand interface is decoupled, the conveyor device automatically switches from automatic operation to manual operating mode. If a user thus removes the mobile operating part 104 from the holder in the stationary operating part 102, this is equivalent to the key switch 112 being flipped. This can therefore also be dispensed with in this design.

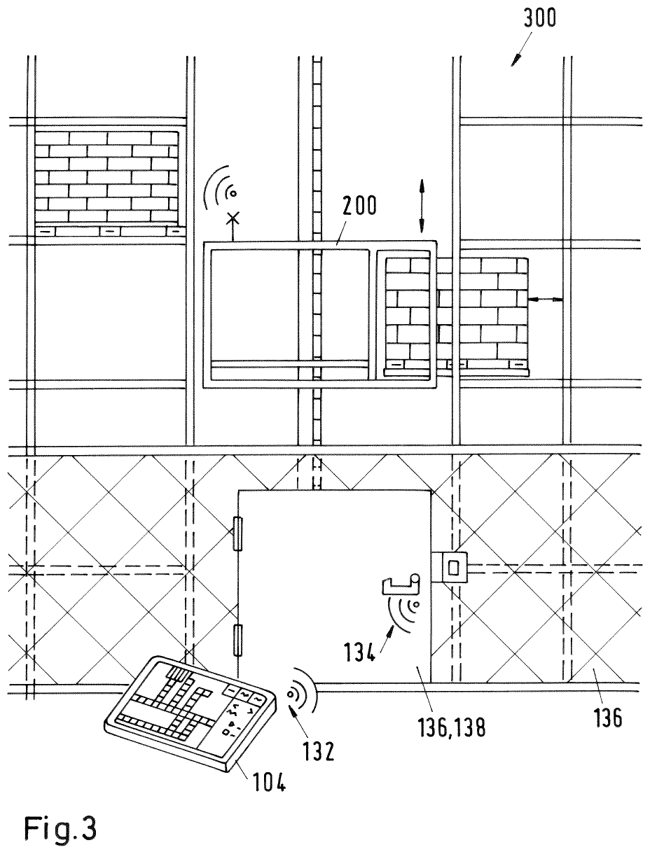

FIG. 3 shows the storage system 300, which includes a safety barrier 136 and an access door 138. In the present case, the safety barrier 136 is implemented by means of a mesh screen, wherein the access door is normally locked and can only be opened in manual operating mode. Due to the physical removal of the mobile operating part 104 from the stationary operating part 102, the conveyor device 200 is in manual operating mode. The mobile operating part 104 can communicate with a locking device of the access door 138 via a wireless communication link. In other words, there is an access interface which is formed by a first interface part 132 of the mobile operating part 104, and which is formed by a second interface part 134 of the access interface, which is complementary to the first interface part 132 and paired with the safety barrier 136. If the first interface part 132 is coupled with the second interface part 134 (possibly with an additional “digital” key exchange), the access door 138 is unlocked, i.e., the safety barrier 136 is moved to the open position. A user can then enter the danger zone 304, wherein the mobile operating part 104 can then communicate with the conveyor device 200 so that it executes appropriate commands. This is illustrated by a small antenna on the conveyor device 200 in FIG. 3.

After leaving the danger zone 304, after closing and locking the access door 138 and after inserting the mobile operating part 104 into the stationary operating part 102, automatic operation of the conveyor device 200 can be restarted.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An operating stand for a conveyor device, the operating stand comprising:
a stationary operating part; and
a mobile operating part that is paired with the stationary operating part, the mobile operating part being physically separated from the stationary operating part,
wherein the stationary operating part comprises at least one safety-relevant safety device adapted to be actuated by a user,
wherein the mobile operating part comprises a user interface adapted to be operated by the user, for manually controlling at least one non-safety-relevant function of the conveyor device.

2. The operating stand according to claim 1, wherein the safety device is an emergency stop button, an operating mode selector switch, or enabling button.

3. The operating stand according to claim 1, wherein the mobile operating part is equipped with a microprocessor, and wherein the mobile operating part for controlling the conveyor device is set up to establish a communication link with a programmable logic controller of the conveyor device directly and to maintain it, at least temporarily.

4. The operating stand according to claim 1, wherein the mobile operating part is set up to establish and, at least temporarily, maintain a communication link with a higher-level visualization server, which is in a communication link with a programmable logic controller of the conveyor device.

5. The operating stand according to claim 1, wherein the stationary operating part comprises a first interface part of an operating stand interface, wherein the mobile operating part comprises a second interface part of the operating stand interface, which is complementary to the first interface part, and wherein automatic operation of the conveyor device is only possible if the first interface part and the second interface part are coupled together.

6. The operating stand according to claim 5, wherein, when the operating stand interface is decoupled, the conveyor device automatically switches from automatic mode to manual mode.

7. The operating stand according to claim 1, wherein the mobile operating part comprises a first interface part of an access interface, which is paired with a safety barrier adapted to be adjusted between an open and a closed position, wherein the coupling of the first interface part of the access interface with a second interface part of the access interface, which is complementary to the first interface part of the access interface, causes the safety barrier to be transferred to the open position.

8. The operating stand according to claim 1, wherein the manual control of at least one non-safety-relevant function is formed by drive commands for the conveyor device.

9. A storage system comprising:
the operating stand according to claim 1; and
a conveyor device that is adapted to be paired with the operating stand for the storage and retrieval of goods.

10. The storage system according to claim 9, wherein the at least one safety-relevant safety device adapted to be actuated by the user is wired to an input card of a programmable logic controller of the conveyor device.

11. The storage system according to claim 9, wherein the mobile operating part is equipped with a microprocessor and comprises a user interface, and wherein the mobile operating part for controlling the conveyor device is set up in such a way as to establish a communication link with a programmable logic controller of the conveyor device directly and to maintain it, at least temporarily.

12. The storage system according to claim 9, wherein the mobile operating part is set up to establish and, at least temporarily, maintain a communication link with a higher-level visualization server, which is in a communication link with a programmable logic controller of the conveyor device.

13. The storage system according to claim 9, wherein the stationary operating part comprises a first interface part of an operating stand interface, wherein the mobile operating part comprises a second interface part of the operating stand interface, which is complementary to the first interface part, and wherein automatic operation of the conveyor device is only possible if the first interface part and the second interface part are coupled together.

14. The storage system according to claim 13, wherein, when the operating stand interface is decoupled, the conveyor device automatically switches from automatic mode to manual operating mode.

15. The storage system according to claim 9, further comprising a safety barrier that is adjustable between an open and a closed position, which separates a working and/or traffic area of the user from a danger zone in which the conveyor device is located, wherein the mobile operating part is a first interface part of an access interface of the safety barrier, and wherein a coupling of the first interface part of the mobile operating part with a second interface part of the access interface, which is complementary to the first interface part and assigned to the safety barrier causes the safety barrier to be transferred to the open position.

16. An operating stand for a conveyor device, the operating stand comprising:
a stationary operating part comprising at least one safety-relevant device actuatable by an operator, the safety relevant device being an emergency stop button, an operating mode selector switch, or an enabling button; and
a mobile operating part to wirelessly provide the conveyor device with at least one non-safety relevant command, the at least one non-safety relevant command comprising a driving command, a lifting command, or a lowering command, the mobile operating being handheld and communicationally paired with the stationary operating part such that the mobile operating part is adapted to be physically separated from the stationary operating part,
wherein the mobile operating part does not comprise the safety-relevant device arranged on the stationary operating part such that the safety-relevant device is only arranged on the stationary operating part.

17. The operating stand according to claim 16, wherein the emergency stop button brings the conveyor device to an immediate stop when operated, wherein the operating mode selector switch, when actuated, switches the conveyor device from an automatic mode to a manual mode, and wherein the enabling button facilitates a release of a drive of the conveyor device to allow movement.

18. The operating stand according to claim 16, wherein the stationary operating part does not comprise the at least one non-safety relevant command provided by the mobile operating part.

19. The operating stand according to claim 16, wherein the mobile operating part only provides non-safety relevant commands to the conveyor.

20. The operating stand according to claim 16, wherein the stationary operating part only comprises the safety-relevant device such that the non-safety-relevant commands are only provided to the conveyor by the mobile operating part.
